(19) United States
(12) Patent Application Publication
(10) Pub. No.: US 2024/0416872 A1
(43) Pub. Date: Dec. 19, 2024

(54) FRONTAL SECTION CAMERA ARRANGEMENT, VEHICLE, METHOD AND COMPUTER PROGRAM

(71) Applicant: ZF CV Systems Global GmbH, Bern (CH)

(72) Inventors: Guillermo Bertolina, Brussels (BE); Tobias Klinger, Springe (DE); Rodrigo Magalhaes Pereira, Munich (DE); Tobias Werle, Hannover (DE)

(21) Appl. No.: 18/815,462

(22) Filed: Aug. 26, 2024

Related U.S. Application Data
(63) Continuation of application No. PCT/EP2022/054664, filed on Feb. 24, 2022.

(51) Int. Cl. B60S 1/56; B60R 1/24; B60R 11/00; B60R 11/04; B60S 1/48; B60S 1/54

(52) U.S. Cl. CPC B60S 1/56; B60R 1/24; B60R 11/04; B60S 1/485; B60S 1/54; B60R 2011/004; B60R 2300/301

(57) ABSTRACT

A frontal section camera arrangement includes a camera arrangement and a frontal section appliance for being arranged on a frontal section of the vehicle. The camera arrangement includes a camera unit configured to provide image data and a camera cleaning unit adapted to clean the camera unit, and including a compressed air provision unit for an air-based cleaning process; and a liquid provision unit for a liquid-based cleaning process. A cleaning control unit is configured to detect a contamination on the camera unit and activate the air-based cleaning process, and, upon determining that the contamination has not been removed, to additionally or alternatively activate the liquid-based cleaning process thus enabling an improved use of the cleaning resources.

### CROSS-REFERENCE TO RELATED APPLICATION

This application is a continuation application of international patent application PCT/EP2022/054664, filed Feb. 24, 2022, designating the United States, and the entire content of the application is incorporated herein by reference.

### TECHNICAL FIELD

The present disclosure is directed to a frontal section camera arrangement for a vehicle, to a vehicle including the frontal section camera arrangement, to a method for operating a frontal section camera arrangement and to a computer program.

### BACKGROUND

In some jurisdictions, commercial vehicles are legally required to be equipped with Lane Departure Warning Systems that are typically established by camera systems using front-looking cameras situated behind the windshield. This particular mounting position has the disadvantage that the very near field in front of a commercial vehicle cannot be observed by that camera, especially in case of US trucks with the cabin behind the engine.

Another disadvantage is that additional advanced driver assistance system (ADAS) functions, such as the detection of smaller objects like, for example, traffic signs or lights, cannot be accomplished because of the shaking of the suspended cabin. Yet another disadvantage is that the direct field of vision is limited by the camera head itself, which has a negative impact on the New Car Assessment Programme (NCAP) rating.

Document WO 2019/209791 A1 presents a vehicle sensor cleaning system that includes one or more vehicle sensors, including external view cameras, and a cleaning device. The system determines parameters for a cleaning event based on sensed information, operating parameters of the vehicle, or environmental information. The system cleans the one or more sensors to allow for safe operation of the vehicle.

There is still a need to improve cleaning especially of a camera arrangement.

### SUMMARY

An object of the disclosure is to provide an improved arrangement and method, namely at least a frontal section camera arrangement with improved cleaning and a method for operating the frontal section camera arrangement. In particular it is an object to implement in a frontal section camera arrangement a fully automated cleaning system and further enable an optimized consumption of the available cleaning resources for the frontal section camera arrangement.

The frontal section camera arrangement includes a camera arrangement and a frontal section appliance for being arranged on a frontal section of an exterior of the vehicle. The camera arrangement includes a camera unit that is arranged on the frontal section appliance for the frontal section of the exterior of the vehicle, which is, in particular, a chassis or bumper of the vehicle, and configured to provide image data.

The camera arrangement also includes a camera cleaning unit adapted to clean the camera unit of the camera arrangement, wherein the camera cleaning unit includes a compressed air provision unit for providing compressed air for use in an air-based cleaning process for the camera unit, and also includes a liquid provision unit for providing a liquid for use in a liquid-based cleaning process for the camera unit.

The camera cleaning unit is configured to receiving operation instructions for driving the camera cleaning unit in the air-based cleaning process and/or the liquid-based cleaning process. The camera arrangement further includes a cleaning control unit that is connected to the camera unit for receiving the image data and is also connected to the camera cleaning unit for providing the operation instructions. In the frontal section camera arrangement of the first aspect of the disclosure, the cleaning control unit is advantageously configured to detect a contamination, on the camera unit and, upon detecting the contamination on the camera unit, to activate the air-based cleaning process by providing an operation instruction indicative thereof. Further, upon determining that the contamination is still on the camera unit, after having performed the air-based cleaning process during a predetermined process time, the cleaning control unit is configured to additionally or alternatively activate the liquid-based cleaning process by providing an operation instruction indicative thereof.

Thus, the frontal section camera arrangement, which, upon operation, is intended to be arranged via the frontal section appliance to the exterior of the vehicle, in particular to the chassis, bumper or any other part of the vehicle that is decouple from shaking movements of the cabin caused by vehicle dynamic effects, enables a fixed orientation of the camera unit while providing a field of view that is not obstructed by vehicle components such as wipers, motor compartment, et cetera, and not obstructing the field of view of the driver. However, since the camera is positioned on the exterior of the vehicle, a cleaning of the camera unit is mandatory. The downside of the exterior mounting position is that the camera unit is exposed to contamination, so that a cleaning of the camera lens becomes necessary. Because typically, but not necessarily, the camera is configured to fulfill ADAS functions and the driver usually does not see the image for a supervision of its cleanliness, an automatic cleaning is beneficial. However, if contamination detection is triggered too often in known cleaning systems, the limited cleaning resources such as water or other cleaning liquids may be used in a non-efficient manner. The frontal section camera arrangement therefore has a camera cleaning unit that is operable in different operation processes, namely an air-based cleaning process that uses compressed air from a compressed air provision unit, and a liquid-based cleaning process that uses a liquid provided by a liquid provision unit.

First, upon detection of a contamination on the camera unit, the air-based cleaning process is activated. Contamination refers to any material located on the camera unit and obstructing its intended field of view, and includes, for example, mud, dust, water drops, snow, ice, oil, grease, insects, etc. If after a predetermined process time, the contamination on the camera unit has not disappeared, the cleaning control unit alternatively or additionally activates the liquid-based cleaning process, thus saving the liquid resource in cases where the air-based cleaning process is sufficient to eliminate the contamination and clean the camera unit.

Thus, the frontal section camera arrangement provides an efficient and fully automated solution for removing contamination of the camera unit located in an exterior of the vehicle, while further enabling an optimized consumption of the available cleaning resources, for instance, the liquid used in the liquid-based cleaning process.

In the following, embodiments of the frontal section camera arrangement of the first aspect of the disclosure will be described.

In an embodiment, the camera unit can be mounted or arranged at the foremost position of the vehicle. By mounting the camera to the foremost position of the vehicle, the blind areas in front of the vehicle are reduced or eliminated, because the motor compartment is taken out of the camera's field of view. Furthermore, the effect of cabin movements propagated to the camera and affecting the stability of its orientation is mitigated by assembling the camera on the chassis. Since with the exterior mounting position the camera in the cabin becomes obsolete, the direct field of vision for the driver is increased by positioning the camera away from it.

In another embodiment, the frontal section camera arrangement includes a wiping unit including a wiping element and a wiper actuator. The cleaning control unit is further configured to activate the wiping unit for wiping the camera unit, in particular during the liquid-based cleaning process, in particular after provision of the liquid.

In an embodiment, the cleaning control unit is further configured to identify a type of contamination from a predetermined list of identifiable types of contaminations, and to directly select a corresponding one of the air-based cleaning process and the liquid-based cleaning process in dependence on the identified type of contamination and a predetermined association rule between identifiable types of contaminations and cleaning processes. Suitable identifiable contaminants or types of contamination include, for example dust, mud, water, snow, ice, oil, grease and/or insects. Each of the types of contaminations are associated via a predetermined association rule to a starting cleaning process. For example, in a particular embodiment, in the case of mud having been identified as a contaminant from a list of identifiable types of contaminations, it is assumed that an air-based cleaning process with a low air-flow will not suffice to clean the camera unit and the cleaning control unit directly provides an operation instruction indicative of an air-based cleaning process with a high air-flow, or of a liquid-based cleaning process without having to operate the air-based cleaning process in advance.

In an embodiment, the cleaning control unit can be further connected to one or more sensing units of the vehicle for receiving corresponding sensing data. In this particular embodiment, the cleaning control unit is further configured to detect and/or identify the contamination using the sensing data provided or ascertained by the sensing units.

In particular, the sensing units are connected to the cleaning control unit and configured to provide the sensing data used for detecting and/or identifying the contamination on the camera unit and may include one or more of the following sensors.

A wiper status sensor for sensing the state of a wiper unit for wiping, in particular, the windshield and or the headlights. Typically, the wipers are automatically activated when dedicated sensors detect rain. Thus, the state of the wipers is an indication of an expected presence of water on the camera unit. For example, according to the frequency of the wiper, the air-based cleaning process is activated for drying, wherein the cleaning interval is adjusted depending on the frequency of the wiper. In a predictive step, it is estimated to which degree the camera unit is obstructed with raindrops so that the cleaning process can be selected accordingly.

A radar sensor, preferably in a frontward oriented mounting position close to the camera unit. The camera arrangement can be operated together with a front looking radar as a radar sensor. When the data from two different sensors like the camera and the radar need to be merged, it is of great advantage if these sensors are mounted on a common body, so that their relative orientation is fix. The radar sensor is usually arranged alongside with the camera unit in a frontward-oriented mounting position. Here, the cleaning control unit activates the respective cleaning process based on a determination of whether an object observed by the radar (for example, a pedestrian, tree, streetlight, sign, etc.) is also detected by the camera unit itself. The sensing data from the radar sensor is thus compared to the image data provided by the camera unit. If the object or objects detected by the radar are not detected by the camera, or vice versa, the cascade of cleaning processed is initiated as described above. Using contextual information from the radar sensor, the logic for activating the corresponding cleaning process could be, in a particular example, and given that the respective objects are detectable by both sensors, as follows:

First, an object is detected by the radar. If the object is also detected by the camera unit, no cleaning process is activated. If, however, the object is not detected by the camera unit, the cleaning control unit activates the corresponding cleaning process.

Optionally, the predictive step for activating the cleaning process performed by the cleaning control unit takes account of the different detection ranges of the sensors, so that the occurrence of an object that is detected by the radar in the far range can be predicted for the camera in the near field.

If the radar sensor does not detect any object for a certain time, the situation can be classified as non-critical and a cleaning of the camera unit can be initiated,

In addition, the radar sensor can identify if an object is located in front of the camera unit, so that it can be expected that the occlusion is only temporary, and no activation of the cleaning process is required.

Another sensor that can additionally or alternatively uses is a LIDAR sensor, preferably in a frontward oriented mounting position close to the camera unit.

Alternatively, or additionally, an ultrasound sensor, preferably in a frontward oriented mounting position close to the camera unit, and/or an infrared sensor, also preferably in a frontward oriented mounting position close to the camera unit are used for determination and provision of sensing data as explained above.

Further, in another embodiment, the frontal section camera arrangement additionally or alternatively includes an auxiliary camera unit that is different than the camera unit, for providing the sensing data. The auxiliary sensor is in this particular embodiment another camera that is preferably situated on a vehicle side different that that where the camera to be cleaned in installed. For example, a pair of front and rear-view cameras, left and right side looking cameras, or cameras on the truck (front looking) and on the rear-end of the trailer. The cleaning demand is derived from the capability of detecting and re-identifying the same object, where in such constellations, a temporal synchronization based on vehicle odometry and a prediction of the detected object needs to be considered. The logic for activating the corresponding cleaning process is, in a particular example, as follows: if a first sensor, for example first camera unit, detects a specific object, it is predicted via a temporal and dynamic model based on vehicle data, at what time and location the same object would be detected by a second sensor, that is, the second camera unit. If that second camera unit does not recognize the predicted object, a cleaning process of the camera unit is initiated.

In general, and different from a reversing camera, which is optionally equipped with a cleaning system, too, the frontal camera unit for the ADAS is operated for most of the time during vehicle operation. Thus, the cleaning efficiency in terms of resource consumption is even more critical than for a reversing camera, which is operated only sporadically. To realize the most economical resource consumption, a cleaning-process cascade including an air-based cleaning process and a liquid-based cleaning process is advantageously established, leveraging the multipath (air and water) cleaning technology. Different cleaning processes can thus be activated sequentially with increasing resource consumption and intermediate checks of the cleaning success are included to determine either that the camera unit is clean or that further cleaning is required. In particular, the first cleaning process is an air-based cleaning process involving only provision of air. Different airflows can be used, so that if the contamination remains on the sensor, more airflow is provided. A second cleaning process is the liquid, preferably but not limited to water or an aqueous solution, based cleaning process, wherein also different flow rates of the liquid can be uses. Additionally, both cleaning processes can be combined, if required for eliminating the contaminant. Preferably, this procedure is supported by a blockage detection that determines different states of occlusion of contaminants, (for example water droplets, dust, mud, oil, and insects).

If an obstruction or contamination is detected and the type of obstruction is known (or assumed), the obstruction is classified or predicted based on sensor data and/or environmental data, such as weather data. In a particular embodiment, the corresponding cleaning process is activated by the cleaning control unit as follows: cleaning process (air- or liquid-based) is selected according to the expected type, and optionally also the expected persistence of the contamination. For example, water, snow, loose dust, et cetera, can be regarded as level-1 contaminants for which the cleaning process begins with the activation of the air-based cleaning process. Ice, dried or wet dust, mud, et cetera, can be regarded as level-2 contaminants for which a liquid-based cleaning process is activated. This also happens if the air-based cleaning process has failed. Further, in this particular example, oil and grease are considered as level-3 contaminants for which a combination of air- and liquid-based cleaning process is activated. This is also the case when the liquid-based cleaning process has failed. If after the activation of a combination of the air-based and the liquid-based cleaning, for example after a predetermined time span after the activation of the combination, the contaminant or obstruction has not been removed, the cleaning process is deemed as unsuccessful and a corresponding signal is provided, for example to the driver or to the electronic control unit.

If an obstruction or contamination is detected, but type of obstruction or contamination is unknown, the cleaning process is selected and escalated based on success of lower level cleaning, activated with increasing resource consumption. For example, first a level-1 cleaning process consisting of an air-based cleaning process alone is activated, preferably with increasing airflow rate until a maximum flow rate is reached. If unsuccessful, a so-called level-2 cleaning process consisting of a liquid-based cleaning process alone is activated, preferably with increasing liquid flow rate until a maximum flow rate is reached. If unsuccessful, a level-3 cleaning process consisting of a combination of an air-based and a liquid-based cleaning process is activated, preferably with increasing air- and/or liquid flow rate until a maximum flow rate is reached. If after the activation of a combination of the air-based and the liquid-based cleaning, for example after a predetermined time span after the activation of the combination, the contaminant or obstruction has not been removed, the cleaning process is deemed as unsuccessful and a corresponding signal is provided, for example to the driver or to the electronic control unit.

In an embodiment, which may include any or any combination of the technical features described above, the frontal section appliance, includes one or more connection elements for attaching the camera unit to the chassis, grid or bumper of the vehicle. In a further embodiment, the camera cleaning unit is integrated into the frontal section appliance.

In another embodiment, the camera unit and the camera cleaning unit are integrated into a common housing element. Alternatively, in another embodiment, the camera unit and the camera cleaning unit include each a respective housing element and are arranged on the vehicle such that the cleaning unit is able to clean the camera unit.

In yet another embodiment the cleaning control unit is integrated with the camera unit in a common housing element. Alternatively, in another embodiment, the cleaning control unit is part of an electronic control unit of the vehicle that is connected via at least one communication channel to the camera unit and to the camera cleaning unit.

According to a second aspect of the present disclosure, a vehicle that includes a frontal section camera arrangement according to the first aspect of the disclosure is described. In the vehicle, the camera unit of the camera arrangement is arranged on a frontal section of an exterior of the vehicle, in particular a chassis, a grid or a bumper of the vehicle. The vehicle thus shares the advantages of the frontal section camera arrangement of the first aspect of the disclosure or of any of its embodiments.

In the following, advantageous embodiments of the vehicle of the second aspect of the disclosure will be described.

In a particular embodiment, the compressed air provision unit is pneumatically connected to an air compressor of the vehicle for receiving the compressed air. Since typically compressed air is produced using ambient air taken from the environment, there is virtually no shortage of compressed air. Thus, air-based cleaning process is preferred as a starting process in cases where the nature of the contaminant is unknown or in cases whether the nature of the contaminant or obstruction is known or identified and corresponds to a type of contamination which in principle can be cleaned with air according to a predetermined association rule between type of contaminations or contaminants or obstructions (these three terms are regarded as synonyms in the present description) and the cleaning processes (air-based, liquid based and, optionally wipers).

Additionally, or alternatively, the a liquid provision unit is connected or formed by a liquid tank including the liquid, in particular water or an aqueous solution or a liquid containing a cleansing component such as an alcohol or a detergent. In a particular embodiment, the liquid provision unit is or is connected to the tank for storing liquid used for cleaning the windshield of the vehicle. Since this tank has a finite volume, it is desirable to reduce the use of the liquid therein only for those cases where it is truly necessary, that is, for cases where the air-based cleaning process is not sufficient to eliminate the contamination of obstruction on the camera unit.

The object is achieved according to a third aspect of the present disclosure, with a method for operating a frontal section camera arrangement of a vehicle. The method includes:
detecting a contamination on a camera unit provided on a frontal section of an exterior of the vehicle, in particular a chassis, a grill or a bumper of the vehicle;
upon detecting the contamination on the camera unit, activating an air-based cleaning process by providing an operation instruction indicative thereof, causing a compressed air provision unit to provide compressed air for the air-based cleaning process of the camera unit;
upon determining that the contamination is still on the camera unit, after having performed the air-based cleaning process during a predetermined process time, additionally or alternatively activating a liquid-based cleaning process by providing an operation instruction indicative thereof, causing a liquid provision unit to provide a liquid for the liquid-based cleaning process of the camera unit.

Thus, the method of the third aspect shares the advantages of the frontal section camera arrangement of the first aspect of the disclosure or of any of its embodiments.

In the following, embodiments of the method of the third aspect of the disclosure will be described.

In particular, an embodiment of the inventive method further includes:
identifying a type of contamination from a predetermined list of identifiable types of contaminations; and
directly selecting for activation a corresponding one of the air-based cleaning process and the liquid-based cleaning process in dependence on the identified type of contamination and a predetermined association rule between type of contamination and cleaning process.

In yet another embodiment, the method alternatively or additionally includes:
receiving sensing data from one or more sensing units; and detecting and/or identifying a type of contamination using the sensing data, wherein, in particular, the sensing units include one or more of a wiper status sensor;
a radar sensor, preferably in a frontward oriented mounting position close to the camera unit;
a LIDAR sensor, preferably in a frontward oriented mounting position close to the camera unit;
an ultrasound sensor, preferably in a frontward oriented mounting position close to the camera unit;
an infrared sensor, preferably in a frontward oriented mounting position close to the camera unit; or
an auxiliary camera unit different than the camera unit.

In yet another embodiment, the step of detecting and/or identifying a type of contamination using the sensing data, further includes:
selecting an object detected by the camera unit and/or one or more of the sensing units, for example, an object within the field of view of the camera or the field of detection of the corresponding sensing unit;
predicting a location and/or point in time for detecting the selected object by another one of the camera unit or one or more of the sensing units, for example using vehicle data pertaining to the velocity and direction of travel of the vehicle, a position and/or a point in time can be predicted in which the object should be detected by the a sensing unit, or by the camera unit, if the object was first selected from sensing data provided by a sensing unit;
capturing image data by the camera unit and/or sensing data by one or more of the sensing units, in particular to determine whether the selected object is also detected at the predicted location and/or point in time; and
probing whether the selected object has been detected at the predicted location and/or point in time by the camera unit and/or one or more of the sensing units.

Optionally, upon determining that the selected object has not been detected at the predetermined location and/or point in time by the camera unit and/or one or more of the sensing units, the method includes deciding that a contamination on the camera unit has been detected.

A fourth aspect of the disclosure is formed by a computer program including instructions which, when the program is executed by an cleaning control unit of a frontal section camera arrangement, cause the cleaning control unit to carry out the steps of the method of the third aspect of the disclosure.

These and other aspects of the disclosure will be apparent from and elucidated with reference to the embodiments described hereinafter.

The embodiments of the disclosure are described in the following on the basis of the drawings in comparison with the state of the art, which is also partly illustrated. The latter is not necessarily intended to represent the embodiments to scale. Drawings are, where useful for explanation, shown in schematized and/or slightly distorted form. With regards to additions to the lessons immediately recognizable from the drawings, reference is made to the relevant state of the art. It should be borne in mind that numerous modifications and changes can be made to the form and detail of an embodiment without deviating from the general idea of the disclosure.

### BRIEF DESCRIPTION OF DRAWINGS

The invention will now be described with reference to the drawings wherein:

FIG. 1 shows a schematic diagram of a vehicle including a frontal section camera arrangement according to a first embodiment;

FIG. 2 shows a schematic diagram of a front view of a vehicle including a camera unit of a second embodiment of a frontal section camera arrangement according to the disclosure and a plurality of sensing units;

FIG. 3 shows a schematic block diagram of a camera unit of a third embodiment of a frontal section camera arrangement according to the disclosure, the camera unit being arranged on a frontal section appliance for a frontal section of a vehicle;

FIG. 4 shows a schematic block diagram of a camera unit of a fourth embodiment of a frontal section camera arrangement according to the disclosure, where the camera unit and the camera cleaning unit are integrated in a common housing element;

FIG. 5 shows a schematic block diagram of a fifth embodiment of a frontal section camera arrangement according to the disclosure;

FIG. 6 shows a schematic block diagram of a sixth embodiment of a frontal section camera arrangement according to the disclosure;

FIG. 7 shows a schematic block diagram of a seventh embodiment of a frontal section camera arrangement according to the disclosure;

FIG. 8 shows a flow diagram of an embodiment of a method according to the disclosure;

FIG. 9 shows a flow diagram including the steps followed in an embodiment of a method, for detecting and/or identifying a type of contamination; and,

FIG. 10 shows a flow diagram of another embodiment of a method according to the disclosure.

### DETAILED DESCRIPTION

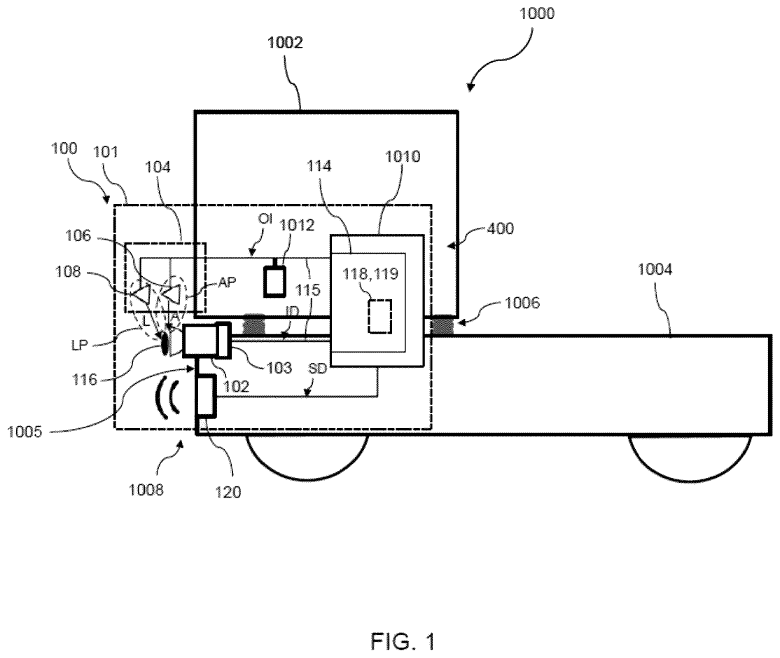

FIG. 1 shows a schematic diagram of a vehicle 1000 including a frontal section camera arrangement 101 in accordance with a first embodiment. In known commercial vehicles (not shown), the driver's cabin 1002 is typically decoupled from the chassis 1004 by a suspension 1006. Typical ADAS cameras are usually mounted in a cabin-fixed position behind the windshield. In this way, the shaking of the cabin 1002 caused by vehicle-dynamic effects, is propagated to the camera. This affects the calibration of the camera and violates the requirement of a fix orientation of the camera. Furthermore, the field of view is partly obstructed by vehicle components (wipers, motor compartment etc.), which is most critical in case of North American Trucks, where the cabin sits behind the motor compartment. Finally, the direct field of vision for the driver himself is decreased by the camera head situated in the area of the windshield. However, in the vehicle 1000 according to the disclosure, the frontal section camera arrangement 101 that is for example suitable for use in an advanced driver assistance system 400 of a vehicle 1000, includes a camera arrangement 100 and a frontal section appliance 103 for being arranged on a frontal section 1008 of an exterior of the vehicle 1000. Since this new inventive solution relies on a new mounting position exterior to the vehicle 1000, a cleaning of the camera arrangement 100, in particular of a camera unit 102 thereof, becomes mandatory.

The camera arrangement 100 includes a camera unit 102 arranged on the frontal section appliance 103 for the frontal section 1008 of the exterior of the vehicle 1000, in particular a chassis 1004 or bumper 1005 or grill of the vehicle 1000. The camera arrangement also includes a camera cleaning unit 104 that is advantageously adapted to clean the camera unit 102. The camera cleaning unit 104 includes a compressed air provision unit 106 that is adapted for providing compressed air A for use in an air-based cleaning process AP for the camera unit 102, and also a liquid provision unit 108 for providing a liquid L for use in a liquid-based cleaning process LP for the camera unit 102. The camera cleaning unit 104 is configured to receiving operation instructions OI for driving the camera cleaning unit 104 in the air-based cleaning process and/or the liquid-based cleaning process.

The camera arrangement 100 further includes a cleaning control unit 114 that is connected to the camera unit 102 for receiving the image data ID and connected to the camera cleaning unit 104 for providing the operation instructions OI. The cleaning control unit 114, in general, is advantageously configured to determine, using the image data, whether a contaminant, contamination or obstruction 116 is on the camera unit 102 and is obstructing the view of the camera unit 102 in a way that interferes with the expected functionality of the camera unit 102 in the ADAS 400. The cleaning control unit 114 is thus advantageously configured to detect a contamination 116 on the camera unit 102 and, upon detecting the contamination 116 on the camera unit 112, to activate the air-based cleaning process AP, by providing an operation instruction OI indicative thereof. After a predetermined process time, that is, time during which the respective process, in this case the air-based cleaning process has been in operation providing air A to clean the camera unit 102, the cleaning control unit checks whether the contamination or the obstruction 116 is still on the camera unit 102. Upon determining that the contamination 116 is still on the camera unit 102, the cleaning control unit is advantageously configured, for example, to increase the flow of air, for instance if the determination indicates that there has been some removal of the contaminant, that is, that the air-based cleaning process has been at least partially effective, or to additionally or alternatively activate the liquid-based cleaning process LP by providing an operation instruction OI indicative thereof, in particular when the determination indicates that the air-based cleaning process has not been effective.

Preferably, the cleaning control unit 114 is further configured to identify a type of contamination 116 from a predetermined list of identifiable types of contaminations 118. Such list 118 is for example stored in the cleaning control unit 114, which is then advantageously configured to directly select a corresponding one of the air-based cleaning process AP and the liquid-based cleaning process LP in dependence on the identified type of contamination 116 and a predetermined association rule 119 between identifiable types of contaminations in the list 118 and a corresponding cleaning processes, for example, AP or LP or a combination of both.

In this particular vehicle 1000, the cleaning control unit 114 is further connected to a sensing unit 120 of the vehicle 1000 for receiving corresponding sensing data (SD). The cleaning control unit 114 is further configured to detect and/or identify the type of contamination 116 using the sensing data SD.

For example, if an obstruction or contamination 116 is detected and the type of contamination corresponds to an item in the list 118, the corresponding cleaning process is activated by the cleaning control unit as follows: cleaning process (air- or liquid-based) is selected according to the identified type of obstruction, and optionally also the expected persistence of the contamination. For example, water, snow, loose dust, et cetera, can be regarded as level-1 contaminants for which the cleaning process begins with the activation of the air-based cleaning process. On the other hand, ice, dried or wet dust, mud, et cetera, can be regarded as level-2 contaminants for which a liquid-based cleaning process is activated. This also happens if the air-based cleaning process has failed. Further, in this particular example, oil and grease are considered as level-3 contaminants for which a combination of air- and liquid-based cleaning process is activated. This is also the case when the liquid-based cleaning process has failed. If after the activation of a combination of the air-based and the liquid-based cleaning, for example after a predetermined time span after the activation of the combination, the contaminant or obstruction has not been removed, the cleaning process is deemed as unsuccessful and a corresponding signal is provided, for example to the driver or to an electronic control unit of the vehicle 1000.

If, on the other hand, an obstruction or contamination is detected, but type of obstruction or contamination is unknown, that is, it does not correspond to an item in the list 118, the cleaning process is selected and escalated based on success of lower level cleaning, activated with increasing resource consumption. For example, first a level-1 cleaning process consisting of an air-based cleaning process alone is activated, preferably with increasing airflow rate until a maximum flow rate is reached. If unsuccessful, a so-called level-2 cleaning process consisting of a liquid-based cleaning process alone is activated, preferably with increasing liquid flow rate until a maximum flow rate is reached. If unsuccessful, a level-3 cleaning process consisting of a combination of an air-based and a liquid-based cleaning process is activated, preferably with increasing air- and/or liquid flow rate until a maximum flow rate is reached. If after the activation of a combination of the air-based and the liquid-based cleaning, for example after a predetermined time span after the activation of the combination, the contaminant or obstruction has not been removed, the cleaning process is deemed as unsuccessful and a corresponding signal is provided, for example to the driver or to an electronic control unit 1010 of the vehicle 1000.

In the vehicle 1000, the camera cleaning unit 104 is connected to an air compressor 1012 that is configured to compress air, in particular ambient air, and to provide compressed air A to the camera cleaning unit 104. The compressor 1012 may be part of a pneumatic system of the vehicle 1000, which is further configured to provide compressed air to other pneumatic units, such as a braking unit or a suspension unit. Alternatively, the compressor unit 1012 is a dedicated unit for providing compressed air A to the camera cleaning unit 104.

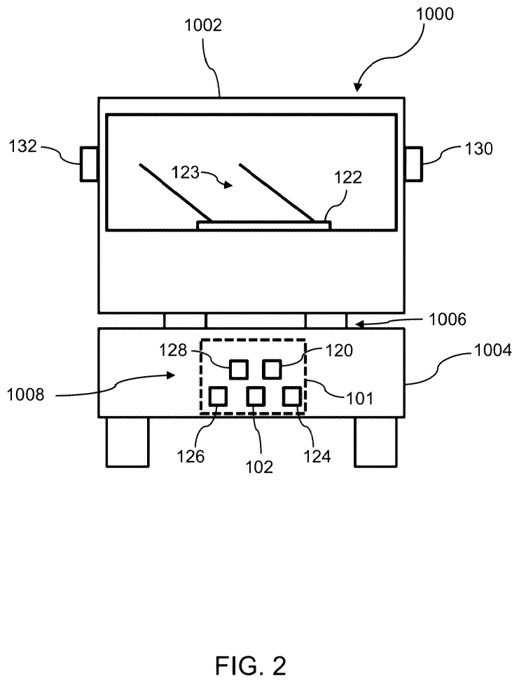

FIG. 2 shows a schematic diagram of a front view of a vehicle 1000 including a camera unit 102 of a second embodiment of a frontal section camera arrangement according to the disclosure and a plurality of sensing units. Those technical features having an identical or similar function are referred to in using the same reference numbers used for the vehicle 1000 of FIG. 1. The vehicle 1000 of FIG. 2 has a plurality of sensing unit that cooperate with the camera unit and provide respective sensing data that is advantageously used to determine the presence and/or the type of contaminant that blocks the view of the camera unit. A particular vehicle may include any combination of the sensing units.

The sensing units 120, 122, 124, 126, 128, 130 and 132 are connected to the cleaning control unit 114, in particular via a CAN bus, and are configured to provide corresponding sensing data SD that is to be used for detecting and/or identifying the contamination 116 on the camera unit 102.

In particular, one of the sensing units is a wiper status sensor 122, adapted for sensing the state of a wiper unit for wiping, in particular, the windshield and or the headlights of the vehicle 1000. Typically, the wipers are automatically activated when dedicated sensors detect rain. Thus, the state of the wipers is an indication of an expected presence of water on the camera unit. For example, according to the frequency of the wiper, the air-based cleaning process is activated for drying, wherein the cleaning interval is adjusted depending on the frequency of the wiper. In a predictive step, it is estimated to which degree the camera unit is obstructed with raindrops so that the cleaning process can be selected accordingly.

Another sensing unit is a radar sensor 120, preferably in a frontward oriented mounting position on the frontal section 1008 of the chassis 1004, close to or proximate the camera unit 102. The camera unit 102 can be operated together with a front looking radar as a radar sensor 120. When the data (ID, SD, see FIG. 1) from the camera unit 102 and the radar sensor 120 need to be merged, it is of great advantage if these sensors are mounted on a common body, so that their relative orientation is fix. Here, the cleaning control unit activates the respective cleaning process based on a determination of whether an object observed by the radar sensor 120 (for example, a pedestrian, tree, streetlight, sign, etc.) is also detected by the camera unit 102. The sensing data from the radar sensor 120 is thus compared to the image data provided by the camera unit 102. If the object or objects detected by the radar sensor 120, are not detected by the camera unit 102, or vice versa, the cascade of cleaning processed is initiated as described above. In addition, the radar sensor 120 can identify if an object is located in front of the camera unit 102, so that it can be expected that the occlusion is only temporary, and no activation of the cleaning process is required.

An additional sensing unit is a LIDAR sensor 124, preferably in a frontward oriented mounting position close to or proximate the camera unit 102, in the frontal section 1008 of the chassis 1004 of the vehicle 1000. The way of operation is similar to that described for the radar sensor 120. The same applies to an ultrasound sensor 126 and/or to an infrared sensor 128.

The vehicle also includes auxiliary camera units 130, 132 different than the camera unit 102, and mounted at the sides of the vehicle. The auxiliary sensors include, in this particular vehicle 1000 of FIG. 2, auxiliary cameras 130, 132 that are arranged on a respective one of the vehicle's right and left side. The cleaning demand is derived from the capability of detecting and re-identifying the same object by the camera unit 102 and at least one of the auxiliary cameras 130, 132, where in such constellations, a temporal synchronization based on vehicle odometry and a prediction of the detected object needs to be considered. The logic for activating the corresponding cleaning process is, in a particular example, as follows: if a first sensor, for example first camera unit 102, detects a specific object, it is predicted via a temporal and dynamic model based on vehicle data, at what time and location the same object would be detected by a second sensor, that is, at least one of the auxiliary camera units 130, 132. If that auxiliary camera unit does not recognize the predicted object, a cleaning process of the camera unit 102 is initiated, as indicated above.

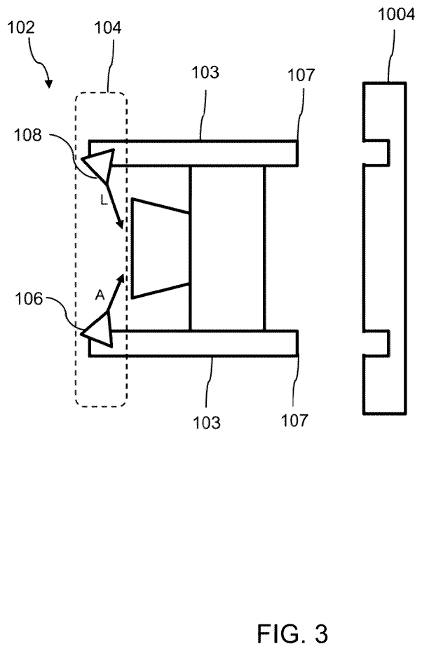

FIG. 3 shows a schematic block diagram of a camera unit 102 of a third embodiment of a frontal section camera arrangement according to the disclosure. The camera unit 102 arranged on a frontal section appliance for a frontal section of a vehicle. FIG. 3 shows a frontal section appliance 103 that includes connection elements 107 for attaching the camera unit 102 to the chassis 1004 of the vehicle 1000. In this particular embodiment, the camera cleaning unit 104 that includes the compressed air provision unit 106 and the liquid provision unit 108 is integrated into the frontal section appliance 103.

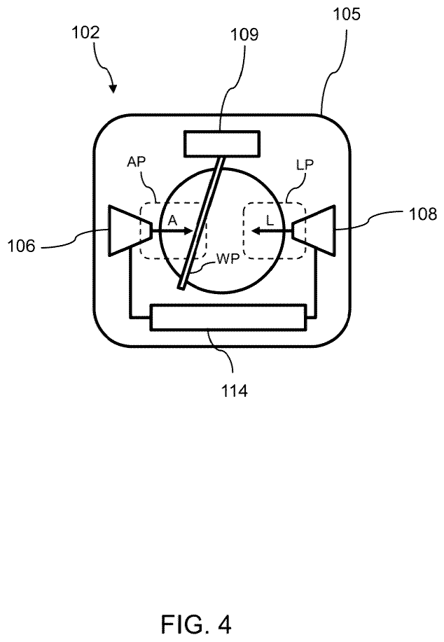

FIG. 4 shows a schematic block diagram of a camera unit 102 of a fourth embodiment of a frontal section camera arrangement according to the disclosure, where the camera unit 102 and the camera cleaning unit 104 are integrated in a common housing element 105. This particular embodiment optionally includes a wiper unit 109 for the camera unit. The cleaning control unit is further advantageously configured to activate a wiper-based cleaning process, which may complement the liquid-based cleaning process. The wiper-based cleaning process is not limited to the embodiment shown in FIG. 4 and can be implemented as an additional cleaning process for any of the camera units 102 discussed above.

Another approach to derive optimal distribution of the cleaning resources is the so called Predictive Cleaning Cross Validation (PCCV) strategy, where-different from a standalone camera-information from sensors other than the one to be cleaned, that is, the camera unit 102, are used to determine the actual demand for cleaning, which is supported by a predictive step in order to estimate when a certain event can be expected relative to the sensor.

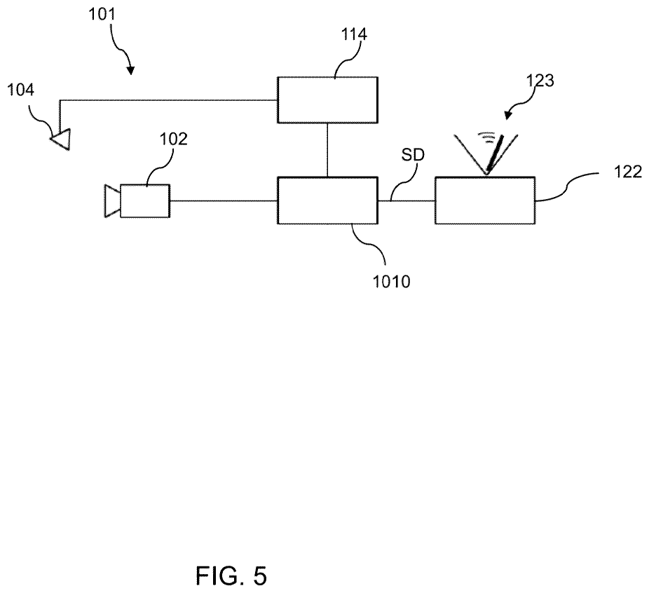

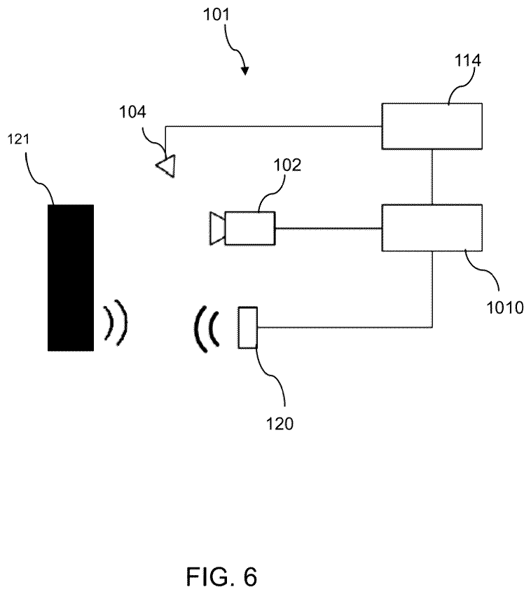

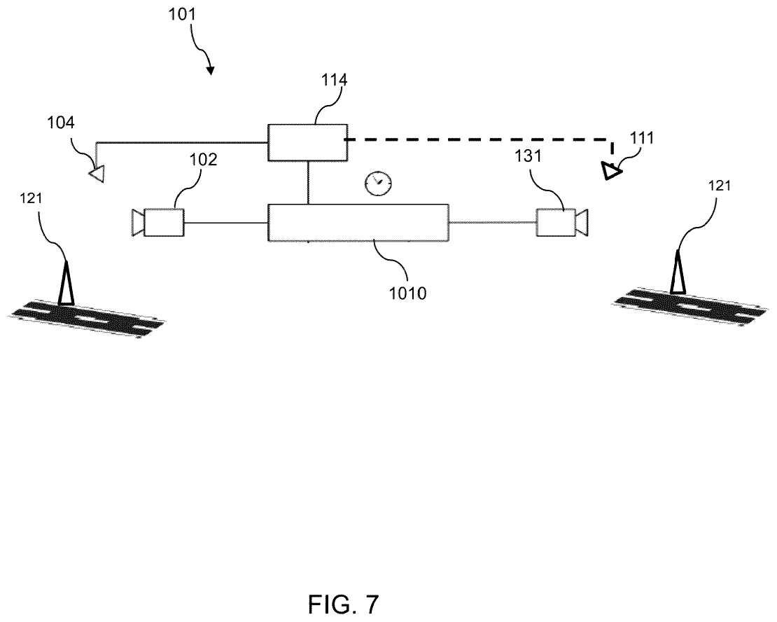

The principle of the Cleaning Cross Validation strategy is to evaluate sensing data that is provided by sensors or sensing units other than the camera unit to be cleaned. The general system architecture includes the camera unit 102 to be cleaned, an ECU 1010 for the activation of the cleaning event, to which at least one other sensor is connected besides the camera unit 102, a camera cleaning unit 104. The logic for the cleaning activation is either directly transferrable from the auxiliary sensor to the camera-cleaning activation or needs to be transformed by considering a temporal synchronization and prediction, as it will be explained in the following with respect to FIG. 5, FIG. 6 and FIG. 7.

FIG. 5 shows a schematic block diagram of a fifth embodiment of a frontal section camera arrangement 101 according to the disclosure. FIG. 5 describes cleaning architecture and logic for cross-validation based on wiper status determined by a wiper-status sensor 122 that provides sensing data SD indicative of the wiper status of a wiper unit 123 to a an electronic control unit 1010. The auxiliary sensing unit 122 measures the wiper status as a vehicle condition. For example, according to the frequency of the wiper, an air-based cleaning process (drying) is activated where the cleaning interval is adjusted depending on the frequency of the wiper. In the predictive step, it is estimated to which degree the camera unit 102 is obstructed with raindrops so that the cleaning profile (for example, frequency, airflow) can be selected accordingly.

FIG. 6 shows a schematic block diagram of a sixth embodiment of a frontal section camera arrangement 101 according to the disclosure. In this embodiment, auxiliary sensing unit is a radar sensor 120, which usually exists alongside with the camera unit 102 in a frontward-oriented mounting position on the frontal section of the chassis of the vehicle 1000. Here, the cleaning demand is derived from a check if an object observed by the radar sensor 120 (for example, a pedestrian) is also detected by the camera unit 102. If this is not the case, a cleaning (cascade) is initiated. Using contextual information from the radar sensor 120, the cleaning logic could be as follows, given that the respective objects are detectable by both the radar sensor 120 and the camera unit 102).

An object 121 is detected by the radar sensor 120. If the object 121 is also detected by the camera unit 102, no cleaning process is activated. If however, the object 121 is not detected by the camera unit 102, a cleaning process is activated. Optionally, the predictive step takes account of the different detection ranges of the radar sensor 120 and the camera unit 102, so that the occurrence of an object 121 that is detected by the radar sensor 120 in the far range, can be predicted for the camera unit 102 in the near field, for example with a time delay depending on the velocity of the vehicle.

If the radar sensor 120 does not detect any object, 121 for a certain time, the situation can be classified as noncritical and, in a particular embodiment, a cleaning process of the camera unit 102 is initiated.

In addition, the radar sensor 120 can identify if an object 121 is located in front of the camera unit 102, so that it can be expected that the occlusion is only temporary, and no cleaning is required.

FIG. 7 shows a schematic block diagram of a seventh embodiment of a frontal section camera arrangement 101 according to the disclosure which includes an auxiliary camera unit 131, in particular a rear camera unit 131 arranged at a rear side of the vehicle. In general, the auxiliary sensor is another camera unit 131 that is situated on a vehicle side different from that where the camera unit 102 is located. This can be, as shown in FIG. 7, a pair of front and rearview camera unit 102, 131, or alternatively left and right side looking cameras, or cameras on the truck (front looking) and on the rear-end of the trailer. As shown in FIG. 7, the auxiliary camera unit 131 may optionally include a dedicated auxiliary cleaning unit 111. The cleaning demand is derived from the capability of detecting and re-identifying the same object 121, where in such constellations, a temporal synchronization based on vehicle odometry and a prediction of the detected object 121 needs to be considered. The cleaning logic is, in a particular embodiment, as follows: if the rear camera unit 131 has detected an object 121, which should have also been detected previously by the camera unit 102 arranged on the frontal section, a cleaning process of the camera unit 102 is initiated. Additionally, in some embodiments, if the camera unit 102 detects a specific object 121, it is predicted via a temporal and dynamic model based on vehicle data, at what time and location the same object 121 should be detected by the rear camera 131. If the rear sensor 131 does not recognize the predicted object 121, a cleaning process is initiated using the camera cleaning unit 111.

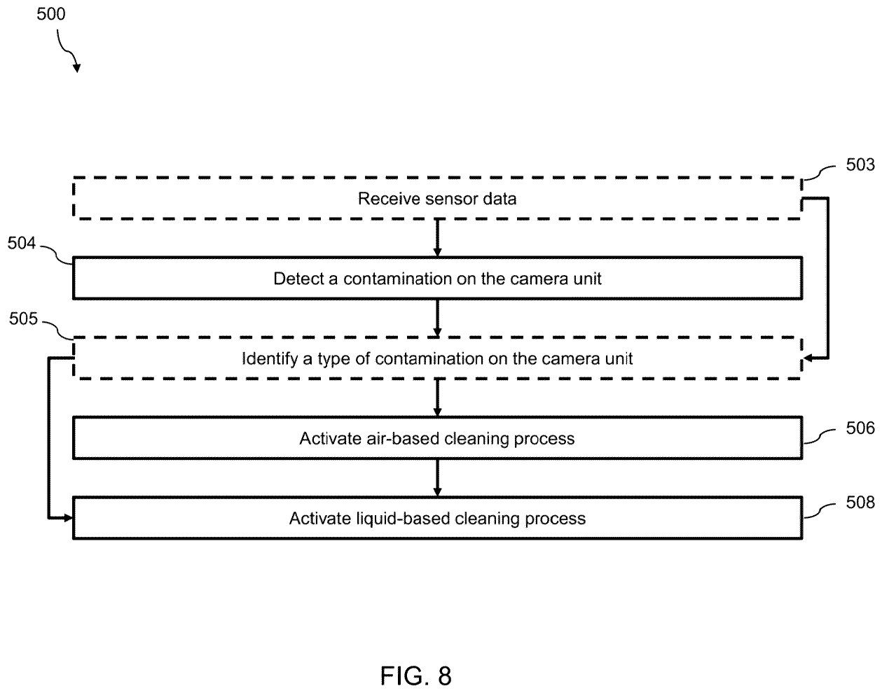

FIG. 8 shows a flow diagram of an embodiment of a method 500 according to the disclosure. The method 500 is suitable for operating a frontal section camera arrangement 101, for example, for an advanced driver assistance system 400 of a vehicle 1000, and includes, in a step 504, detecting a contamination 108 on a camera unit 102 that has been mounted on a frontal section 1008 of an exterior of the vehicle 1000, in particular a chassis 1004 of the vehicle 1000. Upon detecting the contamination 116 on the camera unit 102, the method further includes, in a step 506, activating an air-based cleaning process AP by providing an operation instruction OI indicative thereof, thereby causing a compressed air provision unit 106 to provide compressed air A for the air-based cleaning process AP of the camera unit 102. Further, upon determining that the contamination 116 is still on the camera unit 102, after having performed the air-based cleaning process AP during a predetermined process time t, the method includes, in a step 508, additionally or alternatively activating a liquid-based cleaning process LP by providing an operation instruction OI indicative thereof, thereby causing a liquid provision unit 108 to provide a liquid L for the liquid-based cleaning process LP of the camera unit 102.

The method 500 may include optional steps, indicated by the boxes with discontinuous lines in FIG. 8. In particular, the method may include, in a step 505, identifying a type of contamination 116 from a predetermined list of identifiable types of contaminations 118, and then directly selecting for activation a corresponding one of the air-based cleaning process AP and the liquid-based cleaning process LP in dependence on the identified type of contamination and a predetermined association rule 119 between type of contamination 118 and cleaning process AP, LP.

Also optionally, the method 500 may include, in a step 503, receiving sensing data SD from one or more sensing units 120, 122, 124, 126, 128, 130, 131, 132; and then detecting and/or identifying, in the step 505, a type of contamination 118 using the sensing data SD, wherein, in particular, the sensing units include one or more of
a wiper status sensor 122;
a radar sensor 120, preferably in a frontward oriented mounting position close to the camera unit 102;
a LIDAR sensor 124, preferably in a frontward oriented mounting position close to the camera unit 102;
an ultrasound sensor 126, preferably in a frontward oriented mounting position close to the camera unit 102;
an infrared sensor 128, preferably in a frontward oriented mounting position close to the camera unit 102; or
an auxiliary camera unit 130, 131, 132 different than the camera unit 102.

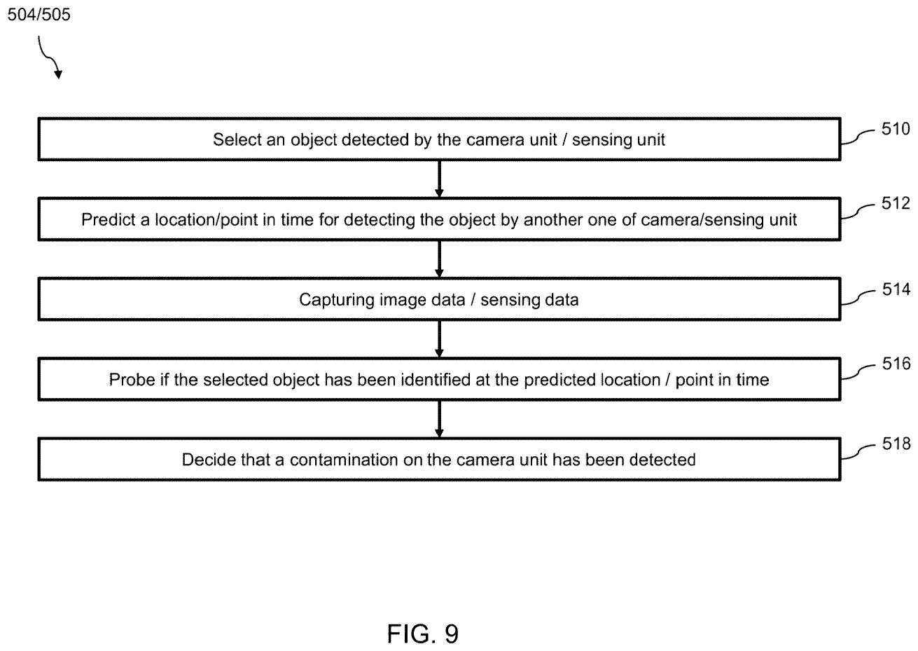

FIG. 9 shows a flow diagram including the steps followed in an embodiment of a method, for detecting 504 and/or identifying 505 a type of contamination. The steps include:
selecting, in a step 510, an object detected by the camera unit and/or one or more of the sensing units, for example, an object within the field of view of the camera or the field of detection of the corresponding sensing unit;
predicting, in a step 512, a location and/or point in time for detecting the selected object by another one of the camera unit or one or more of the sensing units, for example using vehicle data pertaining to the velocity and direction of travel of the vehicle, a position and/or a point in time can be predicted in which the object should be detected by the a sensing unit, or by the camera unit, if the object was first selected from sensing data provided by a sensing unit;
capturing, in a step 514, image data by the camera unit and/or sensing data by one or more of the sensing units, in particular to determine whether the selected object is also detected at the predicted location and/or point in time; and
probing, in a step 516, whether the selected object has been detected at the predicted location and/or point in time by the camera unit and/or one or more of the sensing units.

Optionally, upon determining that the selected object has not been detected at the predetermined location and/or point in time by the camera unit and/or one or more of the sensing units, the method includes, in a step 518, deciding that a contamination on the camera unit has been detected.

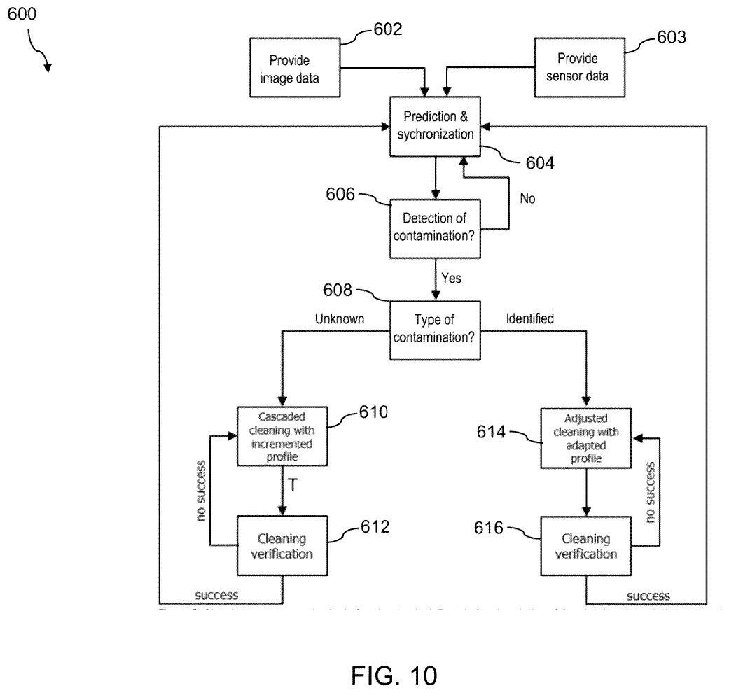

FIG. 10 shows a flow diagram of another embodiment of a method 600 according to the disclosure. Image data is provided, in a step 602 by the camera unit. The image data is used; preferably, in combination with sensor data provided in step 603 by one or more sensing units, to perform a prediction and/or synchronization algorithm in step 604, for example, when a radar sensor with a farther range or a rear camera is used as sensing units, as described above. The output from this algorithm is used to determine if a contaminant is currently making difficult the operation of the camera unit in step 606. If a detection is confirmed, the method moves to step 608, where an identification of the contaminant is performed, using, for example, sensing data from the sensors, or any other available data source, such as, for example weather data indicative of humidity, temperature, weather forecast, etc.

If the type of contamination is unknown, for example, it does not correspond to any type of identifiable contaminant, a cascaded cleaning with incremented profile is started in step 610. First, the air-based cleaning process is activated by providing an operation instruction indicative thereof. Upon determining, in step 612, that the contamination is still on the camera unit, after having performed the air-based cleaning process during a predetermined process time T, step 610 is configured to additionally or alternatively activate the liquid-based cleaning process by providing an operation instruction indicative thereof.

If, on the other hand, the contamination is identified in step 608 as belonging to a list of identifiable types of contaminants, an adjusted cleaning process with a profile adapted to the identified contaminant is started in step 614. For example, a cleaning process (air- or liquid-based) is selected according to the expected type, and optionally also the expected persistence of the contamination. For example, water, snow, loose dust, et cetera, can be regarded as level-1 contaminants for which the cleaning process begins with the activation of the air-based cleaning process. Ice, dried or wet dust, mud, et cetera, can be regarded as level-2 contaminants for which a liquid-based cleaning process is activated. This also happens if the air-based cleaning process has failed, as determined during the verification step 616. Further, in this particular example, oil and grease are considered as level-3 contaminants for which a combination of air- and liquid-based cleaning process is activated. This is also the case when the liquid-based cleaning process has failed. If after the activation of a combination of the air-based and the liquid-based cleaning, for example after a predetermined time span after the activation of the combination, the contaminant or obstruction has not been removed, the cleaning process is deemed as unsuccessful and a corresponding signal is provided, for example to the driver or to the electronic control unit.

In summary, the disclosure is directed to a frontal section camera arrangement including a camera arrangement and a frontal section appliance for being arranged on a frontal section of the vehicle. The camera arrangement includes a camera unit configured to provide image data and a camera cleaning unit adapted to clean the camera unit, and including a compressed air provision unit for an air-based cleaning process, and a liquid provision unit for a liquid-based cleaning process. A cleaning control unit is configured to detect a contamination on the camera unit and activate the air-based cleaning process, and, upon determining that the contamination has not been removed, to additionally or alternatively activate the liquid-based cleaning process thus enabling an improved use of the cleaning resources.

It is understood that the foregoing description is that of the preferred embodiments of the invention and that various changes and modifications may be made thereto without departing from the spirit and scope of the invention as defined in the appended claims.

### LIST OF REFERENCE NUMBERS (Part of the description)

100 Camera arrangement
101 Frontal section camera arrangement
102 Camera unit
103 Frontal section appliance
104 Camera cleaning unit
105 Common housing element
106 Compressed air provision unit
107 Connection element
108 Liquid provision unit
109 Wiper unit of camera unit
111 Auxiliary cleaning unit
114 Cleaning control unit
116 Contamination, contaminant, obstruction
115 Communication channel
118 List of identifiable types of contamination
119 Association rule
120 Sensing unit; radar sensor
121 Object
122 Sensing unit; wiper status sensor
123 Wiper unit
124 Sensing unit; LIDAR sensor
126 Sensing unit; ultrasound sensor
128 Sensing unit; infrared sensor
130 Sensing unit; auxiliary camera unit
131 Sensing unit; auxiliary camera unit
132 Sensing unit; auxiliary camera unit
400 Advanced driver assistance system
500 Method
502-508 Method steps of method 500
600 Method
602-616 Method steps of method 600
1000 Vehicle
1002 Cabin
1004 Chassis
1005 Bumper
1008 Frontal section
1010 Electronic control unit
1012 Air compressor
A Compressed air
AP Air-based cleaning process
ID Image data
L Liquid
LP Liquid-based cleaning process
Operation instructions
SD Sensing data
T Process time
WP Wiper-based cleaning process

1. A frontal section camera arrangement for a vehicle having an exterior defining a frontal section, the frontal section camera arrangement comprising:
a camera arrangement and a frontal section appliance arranged on the frontal section of the exterior of the vehicle; said camera arrangement including:
a camera unit arranged on said frontal section appliance for the frontal section of the exterior of the vehicle and configured to provide image data;
a camera cleaning unit configured to clean the camera unit and said camera cleaning unit including:
a compressed air provision unit for providing compressed air for use in an air-based cleaning process for said camera unit; and,
a liquid provision unit for providing a liquid for use in a liquid-based cleaning process for said camera unit; and,
said camera cleaning unit being configured to receive operation instructions for driving the camera cleaning unit in the air-based cleaning process and/or the liquid-based cleaning process;
said camera arrangement further including:
a cleaning control unit connected to said camera unit for receiving the image data and being connected to said camera cleaning unit for providing said operation instructions;
said cleaning control unit being configured:
to detect a contamination on the camera unit; and,
upon detecting the contamination on the camera unit, to activate said air-based cleaning process by providing an operation instruction indicative thereof;
upon determining that the contamination is still on the camera unit after having performed the air-based cleaning process during a predetermined process time, to additionally or alternatively activate the liquid-based cleaning process by providing an operation instruction indicative thereof.

2. The frontal section camera arrangement of claim 1, wherein said cleaning control unit is further configured to identify a type of contamination from a predetermined list of identifiable types of contaminations and to directly select a corresponding one of the air-based cleaning process and the liquid-based cleaning process in dependence on the identified type of contamination and a predetermined association rule between identifiable types of contaminations and cleaning processes.

3. The frontal section camera arrangement of claim 1, wherein said cleaning control unit is further connected to one or more sensing units of the vehicle for receiving corresponding sensing data; and, said cleaning control unit is further configured to detect and/or identify a type of contamination using the sensing data.

4. The frontal section camera arrangement of claim 3, wherein said sensing units connected to said cleaning control unit and configured to provide the sensing data used for detecting and/or identifying the contamination on the camera unit include one or more of:
a wiper status sensor;
a radar sensor;
a radar sensor in a frontward oriented mounting position close to said camera unit;
a LIDAR sensor;
a LIDAR sensor in a frontward oriented mounting position close to said camera unit;
an ultrasound sensor;
an ultrasound sensor in a frontward oriented mounting position close to said camera unit;
an infrared sensor;
an infrared sensor in a frontward oriented mounting position close to the camera unit; or
an auxiliary camera unit different than said camera unit.

5. The frontal section camera arrangement of claim 1, wherein said exterior of the vehicle includes a chassis; and, said frontal section appliance includes one or more connection elements for attaching said camera unit to said chassis of the vehicle.

6. The frontal section camera arrangement of claim 5, wherein said camera cleaning unit is integrated into said frontal section appliance.

7. The frontal section camera arrangement of claim 1, wherein said camera unit and said camera cleaning unit are integrated into a common housing element.

8. The frontal section camera arrangement of claim 1, wherein said cleaning control unit is integrated with said camera unit in a common housing element, or wherein said cleaning control unit is part of an electronic control unit of the vehicle that is connected via at least one communication channel to said camera unit and to said camera cleaning unit.

9. The frontal section camera arrangement of claim 1, wherein said exterior includes a chassis and/or a bumper.

10. A vehicle comprising:
an exterior defining a frontal section;
a frontal section camera arrangement including:
a camera arrangement and a frontal section appliance arranged on said frontal section of said exterior of the vehicle; said camera arrangement including:
a camera unit arranged on said frontal section appliance for said frontal section of said exterior of the vehicle and configured to provide image data;
a camera cleaning unit configured to clean the camera unit and said camera cleaning unit including:
a compressed air provision unit for providing compressed air for use in an air-based cleaning process for said camera unit; and,
a liquid provision unit for providing a liquid for use in a liquid-based cleaning process for said camera unit; and,
said camera cleaning unit being configured to receive operation instructions for driving the camera cleaning unit in the air-based cleaning process and/or the liquid-based cleaning process;
said camera arrangement further including:
a cleaning control unit connected to said camera unit for receiving the image data and being connected to said camera cleaning unit for providing said operation instructions;
said cleaning control unit being configured:
to detect a contamination on the camera unit; and,
upon detecting the contamination on the camera unit, to activate said air-based cleaning process by providing an operation instruction indicative thereof;
upon determining that the contamination is still on the camera unit after having performed the air-based cleaning process during a predetermined process time, to additionally or alternatively activate the liquid-based cleaning process by providing an operation instruction indicative thereof; and,
said camera unit of the camera arrangement being arranged on the frontal section of the exterior of the vehicle.

11. The vehicle of claim 10, wherein said exterior of said vehicle includes a chassis; and, said camera unit is arranged on said chassis.

12. The vehicle of claim 11, wherein said compressed air provision unit is pneumatically connected to an air compressor of the vehicle for receiving the compressed air.

13. A method for operating a frontal section camera arrangement of a vehicle, the method comprising:
detecting a contamination on a camera unit provided on a frontal section of an exterior of the vehicle;
upon detecting the contamination on the camera unit, activating an air-based cleaning process by providing an operation instruction indicative thereof, causing a compressed air provision unit to provide compressed air for the air-based cleaning process of the camera unit; and,
upon determining that the contamination is still on the camera unit after having performed the air-based cleaning process during a predetermined process time, additionally or alternatively activating a liquid-based cleaning process by providing an operation instruction indicative thereof, causing a liquid provision unit to provide a liquid for the liquid-based cleaning process of the camera unit.

14. The method of claim 13, wherein said exterior includes a chassis and the camera unit is arranged on the chassis.

15. The method of claim 13, further comprising:
identifying a type of contamination from a predetermined list of identifiable types of contaminations; and,
directly selecting for activation a corresponding one of the air-based cleaning process and the liquid-based cleaning process in dependence on the identified type of contamination and a predetermined association rule between type of contamination and cleaning process.

16. The method of claim 13, further comprising:
receiving sensing data from one or more sensing units and detecting the contamination and/or identifying a type of contamination using the sensing data, wherein the sensing units include one or more of:
a wiper status sensor;
a radar sensor;
a radar sensor in a frontward oriented mounting position close to the camera unit;
a LIDAR sensor;
a LIDAR sensor in a frontward oriented mounting position close to the camera unit an ultrasound sensor;
an ultrasound sensor in a frontward oriented mounting position close to the camera unit;
an infrared sensor;
an infrared sensor in a frontward oriented mounting position close to the camera unit; or
an auxiliary camera unit different than said camera unit.

17. The method of claim 13, further comprising receiving sensing data from one or more sensing units and detecting the contamination and/or identifying a type of contamination using the sensing data.

18. The method of claim 13, wherein the step of detecting the contamination and/or identifying a type of contamination further comprises:
selecting an object detected by the camera unit and/or one or more of the sensing units;
predicting a location and/or point in time for detecting the selected object by another one of the camera unit or one or more of the sensing units;
capturing image data by the camera unit and/or sensing data by one or more of the sensing units;
probing whether the selected object has been detected at the predicted location and/or point in time by the camera unit and/or one or more of the sensing units;
wherein, as follow up of the probing:
a determination is made that the selected object has not been detected at the predetermined location and/or point in time by the camera unit and/or one or more of the sensing units based thereon it is decided and/or indicated by a signal that a contamination has been detected.

19. The method of claim 13, wherein the step of detecting the contamination and/or identifying a type of contamination further comprises:
selecting an object detected by the camera unit and/or one or more of the sensing units;
predicting a location and/or point in time for detecting the selected object by another one of the camera unit or one or more of the sensing units;
capturing image data by the camera unit and/or sensing data by one or more of the sensing units;
probing whether the selected object has been detected at the predicted location and/or point in time by the camera unit and/or one or more of the sensing units;
wherein, as follow up of the probing:
a determination is made that the selected object has not been detected at the predetermined location and/or point in time by the camera unit and/or one or more of the sensing units.

20. A computer program comprising instructions which, when the program is executed by a cleaning control unit of a frontal section camera arrangement, cause the cleaning control unit to carry out the steps of:
detecting a contamination on a camera unit provided on a frontal section of an exterior of the vehicle;
upon detecting the contamination on the camera unit, activating an air-based cleaning process by providing an operation instruction indicative thereof, causing a compressed air provision unit to provide compressed air for the air-based cleaning process of the camera unit; and,
upon determining that the contamination is still on the camera unit after having performed the air-based cleaning process during a predetermined process time, additionally or alternatively activating a liquid-based cleaning process by providing an operation instruction indicative thereof, causing a liquid provision unit to provide a liquid for the liquid-based cleaning process of the camera unit.
